(19) United States
(12) Patent Application Publication
(10) Pub. No.: US 2026/0062152 A1
(43) Pub. Date: Mar. 5, 2026

(54) Apparatus and Method for Generating and Controlling Magnetic Fields

(71) Applicant: Universität Stuttgart Körperschaft des öffentlichen Rechts, Stuttgart (DE)

(72) Inventors: Manfred Ehresmann, Stuttgart (DE); Stefanos Fasoulas, Stuttgart (DE); Georg Herdrich, Stuttgart (DE)

(73) Assignee: Universität Stuttgart Körperschaft des öffentlichen Rechts, Stuttgart (DE)

(21) Appl. No.: 19/311,373

(22) Filed: Aug. 27, 2025

(30) Foreign Application Priority Data
Aug. 27, 2024 (EP) 24196599.5

(51) Int. Cl. B64G 1/32; H01F 7/02

(52) U.S. Cl. CPC B64G 1/32; H01F 7/0273

(57) ABSTRACT

An apparatus for generating and controlling magnetic fields is proposed, which comprises at least two permanent magnets, wherein each permanent magnet generates a partial magnetic field, and wherein the permanent magnets are each movably mounted, so that each permanent magnet can be brought into at least two positions and the apparatus is formed to generate at least three different magnetic field states as a superposition of the partial magnetic fields.

The present invention relates to an apparatus as well as to a method for generating and controlling magnetic fields, and also to the use of a corresponding apparatus for position control in space travel according to the independent claims.

In prior art there are already solutions for controlling and manipulating magnetic fields, particularly with regard to the spatial position of spacecraft. For example, permanent magnets, electromagnets, electropermanent magnets, or superconducting magnets can be used for this purpose.

Permanent magnets are generally difficult to control and, above all, cannot be “deactivated.” Electromagnets allow precise control of magnetic fields, but require a continuous supply of energy to maintain the magnetic field. Electropermanent magnets have an improved energy efficiency compared to electromagnets, but can be more complex to manufacture due to the switching and stabilization of the magnetic field. Superconducting magnets generate strong and stable magnetic fields, but require very low temperatures and special materials to enable superconductivity. This limits their possible applications and, in many cases, makes them too expensive and complicated.

The present invention is based on the task of further developing an apparatus for generating magnetic fields in such a way that the above-mentioned disadvantages are overcome. In particular, the apparatus should provide an efficient, precise, and energy-efficient means of generating and controlling magnetic fields.

The above-mentioned task is solved by an apparatus for generating and controlling magnetic fields, which comprises at least two permanent magnets. Each permanent magnet generates a partial magnetic field. The permanent magnets are each movably, in particular rotatably, mounted, so that each permanent magnet can be brought into at least two, in particular exactly two, positions. Thus, the apparatus can generate at least three different magnetic field states as superpositions of the partial magnetic fields.

The permanent magnets can be configured as neodymium magnets. The positions are stable positions, which means that the permanent magnet remains in the respective position without the need for a supply of energy. The at least three different magnetic field states generated are therefore also stable magnetic field states that are maintained without the supply of energy. Energy is only required for the switching process between different magnetic field states.

The three different magnetic field states generated are formed by superimposing the partial magnetic fields. The arrangement of the permanent magnets thus determines the magnetic field state. Each permanent magnet has a positive and a negative part.

An initial arrangement can generate a first magnetic field state. This state is referred to here as positive, for example. The positive part of both permanent magnets points in a first direction.

If the positive part of the permanent magnets points in the opposite direction, the second direction, a second arrangement and thus the second magnetic field state is present, which is referred to here as negative, for example.

If the permanent magnets, or their positive parts, point in different directions, a neutral magnetic field state is created. In this magnetic field state, the partial magnetic fields of the magnetic fields compensate each other, so that the total magnetic field is zero. This is therefore an efficient way of switching off the apparatus in order to avoid, for example, negative interference effects that can generate the permanent magnetic field of a permanent magnet.

Overall, a tristable system is thus proposed with which three stable magnetic field states can be generated in an energy-efficient manner. The apparatus does not require a continuous supply of energy to “maintain” the magnetic field states. Energy is only required for switching. The apparatus offers an enormous advantage, especially for applications in which energy efficiency and battery life are important.

In particular, the permanent magnets are mounted so that they can be rotated magnetically in order to move them into different positions. This is preferably achieved using a ferrofluid bearing. The permanent magnets can each be suspended in a ferrofluid. Each individual magnet is thus completely surrounded by ferrofluid. The magnetic nanoparticles in the ferrofluid are attracted to the magnetic poles and thus form a cushion that has its own pressure, namely the magnetic pressure of the liquid. This pressure ensures that other materials which are non-magnetic are pushed away, and thus prevents a physical contact. This results in a very low-friction surface, as only the oil surface is in contact. This type of mounting and switching is a particularly low-wear, reliable, and long-lasting solution.

Energy is only required for the switching process, i.e., changing the orientation of the permanent magnets. The permanent magnets each have two longitudinal ends. A respective coil can be arranged at both longitudinal ends of a permanent magnet in at least two stable states. The coils can be energized. Both permanent magnets are connected to a common magnetic connection piece on the corresponding side via the respective coil. The permanent magnets are thus connected to two connection pieces. The apparatus therefore preferably has at least one coil per longitudinal side for two permanent magnets. There can thus preferably be present exactly two, three, or four or more coils and at least, preferably exactly two, connection pieces. The coils serve to generate a local magnetic field and move the permanent magnets into a new stable position. The position of the coils remains constant while the magnet moves. For example, a permanent magnet can be arranged in a first stable position with the positive part at a first coil and with the negative part at the second coil. If the permanent magnet moves from the first position to the second position, the positive part is now in contact with the second coil, while the negative part is arranged at the first coil.

The at least two connection pieces are required to short-circuit the partial magnetic fields of the permanent magnets in the magnetically neutral state and to concentrate them in the other states as a constant external magnetic field. They thus serve to superimpose the partial magnetic fields of the permanent magnets.

Alternatively, the permanent magnets can be mounted so that they can be rotated mechanically, for example by means of at least one motor, preferably an electric motor or a servo motor, in a self-locking configuration. For example, a motor that is configured to move the permanent magnet into a different position can be assigned to each permanent magnet.

The at least two permanent magnets are, above all, identically formed. In particular, they have an identical geometry and/or identical surface magnetization and/or identical magnetic dipole torque.

The apparatus may comprise more than two permanent magnets, wherein the permanent magnets may be arranged next to each other in one spatial direction. The permanent magnets thus extend one-dimensionally in one spatial direction and are therefore connected at one respective longitudinal end via coils with a common connection piece and at the other longitudinal end also via coils with a common connection piece. The combination of at least two, for example two, three or four, permanent magnets with coils and two connection pieces can be understood as a magnetic unit. Preferably, there are always twice as many coils as permanent magnets. Preferably, the apparatus is a total magnet with a variable magnetic field, which can comprise several such units.

With more than two permanent magnets, more than three magnetic field states are possible. This allows for a finer adjustment of the strength of the generated magnetic field states and thus greater effects, for example larger magnetic fields, compared to a unit consisting of only two permanent magnets.

Alternatively, the apparatus may comprise several magnetic units (with their own connection pieces) arranged linearly next to each other in one spatial direction. In such a case, the above-mentioned advantages of finer adjustability and greater effects are also present.

Furthermore, the apparatus may comprise more than two permanent magnets, wherein the permanent magnets are arranged in a two-dimensional arrangement. This means that at least two permanent magnets each are arranged in at least two spatial directions, wherein the spatial directions are not parallel to each other. The spatial directions are preferably perpendicular to each other. While at least two permanent magnets lie in one spatial plane, at least two permanent magnets of all permanent magnets also lie in a common second spatial plane.

Most preferably, the apparatus has more than three magnetic units arranged in a two-dimensional arrangement. At least two units can be arranged next to each other in a first spatial direction and at least two units in a second, preferably perpendicular, spatial direction. This is an extension in two linear spatial directions, which allows generating magnetic fields in two-dimensional form in the plane formed by the two spatial directions. The angular resolution can be defined by the number of units used.

Further, the apparatus may comprise more than two permanent magnets, wherein the permanent magnets are arranged in a three-dimensional arrangement. They are arranged such that at least two permanent magnets are arranged in at least two spatial planes. Most preferably, the apparatus has more than three magnetic units which are in a three-dimensional arrangement. At least two units can be arranged next to each other in a first spatial direction and at least two units in a second, preferably perpendicular, spatial direction and at least two units in a third spatial direction, which is preferably perpendicular to the first and second spatial directions. Thus any discrete magnetic fields can be generated in all three spatial directions. This extension into the third spatial direction enables the generation of any 3D magnetic field vector.

The apparatus also has a control unit to control the currents of the coils. In particular, the apparatus refers to a magnetic torque wrench.

In particular, the invention also relates to an application of an above-described apparatus for position control in space, in other words for controlling the spacecraft position control of a spacecraft in orbit, namely orbits in which external magnetic fields are present. These would primarily be low and medium Earth orbits and also orbits around planets such as the gas giants and Mercury. The generated magnetic fields are controlled as efficiently as possible. Precise control of magnetic fields is made possible by switching between the three stable states. This allows for the most energy-efficient control possible with regard to the orientation of spacecraft in orbit, as no continuous supply of energy is required to maintain the magnetic field. The apparatus only requires energy for the switching process. The system can thus control and stabilize the orientation of a spacecraft in orbit without consuming energy on a permanent basis.

Furthermore, when used in space travel, the present apparatus does not cause any interference effects, as is the case with magnetic systems, for example, since the neutral magnetic field state can be switched on and, above all, completely switched off. Permanent magnets in particular generate continuous, unchanging magnetic fields that can cause unwanted interference.

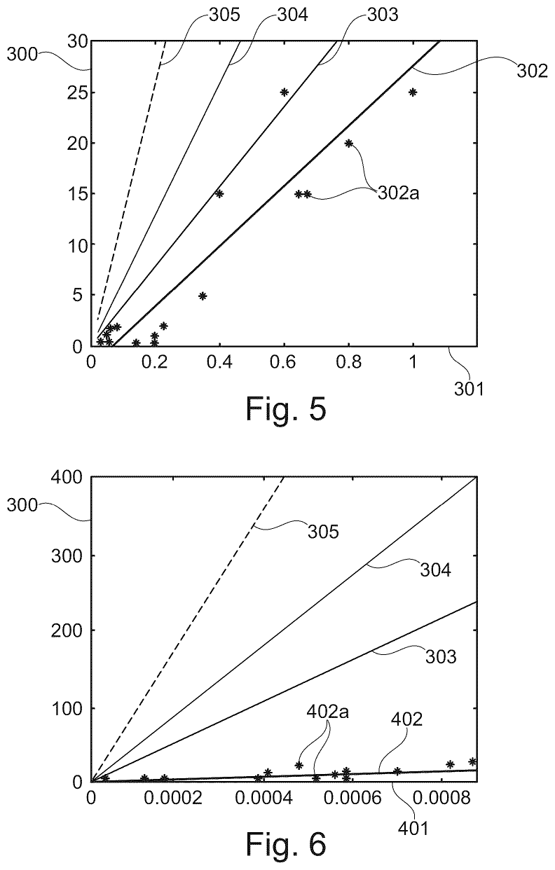

Furthermore, outstanding system efficiency is achieved. Lightweight construction requirements are of great importance in space travel. The apparatus significantly increases system efficiency compared to magnetic torque wrenches from prior art. This increase in system efficiency is over 120 % and is shown in FIG. 5.

The system compactness is also increased, which is particularly relevant in space travel. An increase in system compactness by a factor of 20 is achieved. This is shown in FIG. 6.

Overall, this provides a significantly improved alternative to conventional magnetic torque wrenches, which improves the performance and reliability of space missions. The present invention also represents a significant advance in terms of lightweight construction, energy efficiency, and compactness compared to the prior art.

In addition to its application in space travel, various other applications are possible, for example for the precise generation and control of magnetic fields, for example in medical technology, environmental protection, robotics, or economic research. Possible applications also include magnetic locks, magnetic latches, adjustable holding magnets, magnetic circuits, for example mechanical relays, and electric motors.

In a further aspect, the invention relates to a method for generating and controlling magnetic fields, wherein the method uses a apparatus described above. The method comprises arranging at least one of at least two movably mounted permanent magnets in at least one of two positions. Each permanent magnet generates a partial magnetic field so that one of at least three different magnetic field states is generated as a superposition of the partial magnetic fields. No energy is required to maintain the magnetic field states. Only for switching.

The figures show in purely schematic representation:

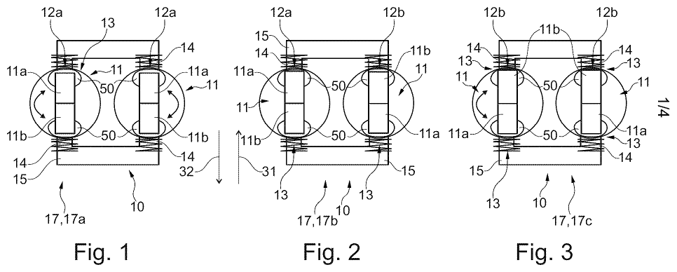

FIG. 1: a top view of an apparatus for generating and controlling magnetic fields;

FIG. 2: another top view of the apparatus according to FIG. 1;

FIG. 3: another top view of the apparatus according to FIGS. 1 and 2;

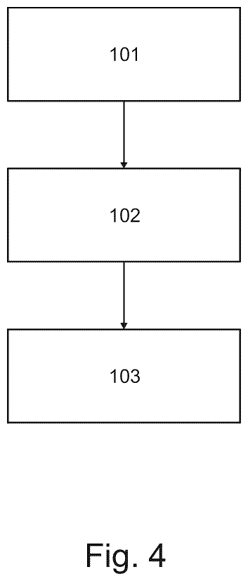

FIG. 4: a method diagram of a method for generating and controlling magnetic fields;

FIG. 5: the magnetic torque plotted against the mass;

FIG. 6: the magnetic torque plotted against the volume;

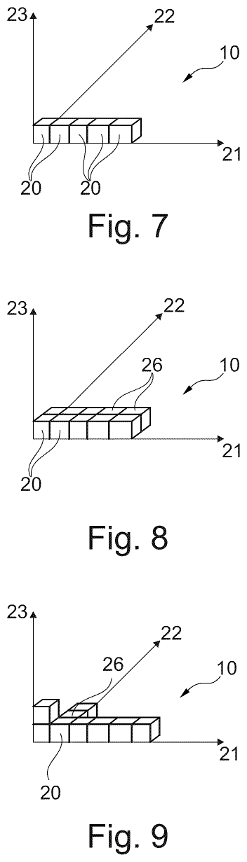

FIG. 7: another apparatus for generating and controlling magnetic fields;

FIG. 8: an apparatus in two-dimensional design; and

FIG. 9: an apparatus in a three-dimensional arrangement.

FIG. 1 shows an apparatus 10 for generating and controlling magnetic fields in a top view, comprising two permanent magnets 11. The permanent magnets 11 have a positive part 11a and a negative part 11b. Coils 14 are arranged at the longitudinal ends 13, and a common connection piece 15 is arranged on each side. In FIG. 1, the apparatus 10 is shown such that the permanent magnets 11 both point upward with their positive part 11a in a first direction 31. Both permanent magnets 11 are thus shown at a first position 12a. The partial magnetic fields overlap and a positive magnetic field state 17a is generated. A ferrofluid bearing 50 is clearly shown, which allows the movement of the permanent magnets 11. Also, an arrow shows the direction of rotation of one of the permanent magnets 11, and a border around the magnets shows their movement when switching to the other position.

FIG. 2 shows the same apparatus 10 as in FIG. 1. The permanent magnet 11 shown on the left in FIG. 2 has remained in the first position 12a, while the permanent magnet 11 shown on the right is now in a second position 12b. Its positive part now points in the second direction 32.

The partial magnetic fields neutralize each other, resulting in a neutral magnetic field state 17b.

FIG. 3 also shows the apparatus 10 according to FIGS. 1 and 2, wherein now both permanent magnets 11 are in a second position 12b. This means that their positive parts 11a each point downwards in the second direction 32, while the negative parts 11b point upwards in the first direction 31. Overall, a negative magnetic field state 17c is generated.

FIG. 4 shows a method diagram of a method 100 for generating and controlling magnetic fields, which uses 101 an apparatus shown in FIGS. 1 to 3. At least one of at least two movably mounted permanent magnets is moved 102 into at least one of two positions. One of three different magnetic field states is generated 103 as a superposition of the partial magnetic fields of the permanent magnetic fields.

In FIG. 5, different graphs concerning the magnetic torque 300 are shown in relation to the mass 301. The magnetic torque 300 is given in Am² and the mass in kg. Data points 302a, from which the first graph 302 is derived, are clearly visible. These refer to conventional systems with corresponding magnetic torque wrenches from the prior art. A second graph 303 refers to electropermanent magnets in the ideal case. The present invention is specified by the third graph 304. A fourth graph 305 shows the theoretical maximum of the ratio between the magnetic torque 300 and the mass 301. It can be clearly seen that the present invention is significantly closer to the maximum and thus to the fourth graph 305 than the solutions known from the prior art, which brings enormous mass-specific advantages.

FIG. 6 shows the magnetic torque 300 against the volume 401. The magnetic torque 300 is shown in Am² and the volume 401 in m³. The data points 402a of a first graph 402 can be seen again. This refers to a magnetic torque wrench known from the prior art. A second graph 403 can be seen, which ideally refers to electropermanent magnets, and a third graph 404, which refers to the present invention. A fourth graph 405 shows the theoretical maximum. Once again, it can be seen that the third graph 404 is significantly closer to the theoretical maximum than solutions known from the prior art.

FIG. 7 shows another apparatus 10. A Cartesian coordinate system with a first spatial direction 21, a second spatial direction 22 and a third spatial direction 23 is shown. Two permanent magnets according to FIGS. 1 to 3 can form a magnetic unit 20. Several magnetic units 20 are arranged in the first spatial direction 21.

FIG. 8 shows an apparatus 10 in two-dimensional form. Magnetic units 20 are arranged in a first spatial direction 21 and in a second spatial direction 22. Magnetic fields can thus be generated in the plane formed by the first spatial direction 21 and the second spatial direction 22.

FIG. 9 shows an apparatus 10 in three-dimensional form. It can be clearly seen how magnetic units 20 are arranged in a first spatial direction 21, a second spatial direction 22, and a third spatial direction 23. Thus magnetic fields with all direction vectors can be generated and controlled.

1. Apparatus for generating and controlling magnetic fields, wherein:
the apparatus comprises at least two permanent magnets,
wherein each permanent magnet generates a partial magnetic field,
wherein the permanent magnets are each movably mounted, so that each permanent magnet can be brought into at least two positions and the apparatus is formed to generate at least three different magnetic field states as a superposition of the partial magnetic fields.

2. The apparatus according to claim 1, wherein:
the permanent magnets are mounted so as to be magnetically rotatable.

3. The apparatus according to claim 2, wherein:
the permanent magnets are mounted via a ferrofluid bearing.

4. The apparatus according to claim 1, wherein:
the permanent magnets are mounted so as to be mechanically rotatable.

5. The apparatus according to claim 1, wherein:
a respective coil is arranged in the at least two positions at each longitudinal end of the permanent magnets,
wherein the permanent magnets are connected via the coils to two common magnetic connection pieces.

6. The apparatus according to claim 1, wherein:
the at least two permanent magnets are identically formed.

7. The apparatus according to claim 1, wherein:
the apparatus comprises more than two permanent magnets,
wherein all permanent magnets are arranged next to one another in a first spatial direction.

8. The apparatus according to claim 1, wherein:
the apparatus comprises more than two permanent magnets,
wherein the permanent magnets are arranged in a two-dimensional arrangement.

9. The apparatus according to any of claim 5, wherein:
at least two permanent magnets with coils and two connection pieces represent a magnetic unit,
wherein the apparatus comprises more than two magnetic units.

10. The apparatus according to claim 9, wherein:
the apparatus comprises at least three magnetic units in a two-dimensional arrangement.

11. The apparatus according to claim 9, wherein:
the apparatus comprises at least four magnetic units in a three-dimensional arrangement.

12. Use of the apparatus according to claim 1 for position control in space travel.

13. A method for generating and controlling magnetic fields, wherein:
the method uses the apparatus according to claim 1,
wherein the method comprises moving at least one of at least two movably mounted permanent magnets into at least one of two positions,
wherein each permanent magnet generates a partial magnetic field such that one of at least three different magnetic field states is generated as a superposition of the partial magnetic fields.
